(19) United States
(12) Patent Application Publication
(10) Pub. No.: US 2002/0069126 A1
(43) Pub. Date: Jun. 6, 2002

(54) Auction information provision system capable of providing reliable information for both purchaser and seller

(75) Inventor: Terumasa Matsushima, Tokyo (JP)

Correspondence Address: SCULLY, SCOTT, MURPHY & PRESSER, 400 Garden City Plaza, Garden City, NY, 11530, US

(73) Assignee: NEC Corporation, Tokyo (JP)

(21) Appl. No.: 09/903,250

(22) Filed: Jul. 11, 2001

(30) Foreign Application Priority Data
Jul. 11, 2000 (JP) 2000-209337

(51) Int. Cl. G06F 17/60

(52) U.S. Cl. 705/26

(57) ABSTRACT

In an auction information provision system, information for desirable goods to be purchased are previously registered on an auction management server 20 from an user (purchaser) terminal 10B. The auction management server 20 supplies the information for desirable goods over a network NW. When goods complying with the information for desirable goods are registered as information for exhibitted goods from an user (exhibitter) terminal 10C, the auction management server 20 automatically notices the user (purchaser) terminal that the goods complying with the information for desirable goods are exhibitted in the auction.

### BACKGROUND OF THE INVENTION

The present invention relates to an auction information provision system and a method of providing auction information, in particular to such a system and a method by which a purchaser is reliably able to know that desired goods are exhibited in the auction and by which a seller is reliably able to know presence of the purchaser who wants to buy the seller's goods.

Traditional auctions usually take the form of a physical gathering of bidders assembled together within an auction house.

Electronic auctions held over a network, such, as the Internet, or the like have provided an innovation as compared to more traditional physical options. Recently, some electronic auctions using the Internet's World Wide Web (WWW) facility to post descriptions of the merchandise are conducted. In those conventional electronic auctions, sellers register their goods to be sold in a home page of the auction unilaterally while purchasers search desired goods for themselves to take perticipate in a bidding of the auction.

However, the conventional electronic auctions have some problems.

First, a purchaser, that is, a person who wants to buy goods in the auction, must access a home page of the auction to search his desired goods, even though the desired goods were not exhibitted in the auction. This brings an unefficiency of time for the purchaser. In addition, it is a waste of money to pay a communication cost for the access.

Second, a seller, that is, a person who wants to sell his goods in the auction, must exhibit the goods therein, even though any purchasers who want to buy the goods did not perticipated in the auction. It is often the case that no person takes participate in a bidding of the auction.

### SUMMARY OF THE INVENTION

It is therefore an object of the present invention to provide an auction information provision system and a method of providing auction information by which a purchaser is reliably able to know that desired goods are exhibited in the auction and by which a seller is reliably able to know presence of the purchaser who wants to buy the seller's goods.

Other objects of the present invention will become clear as the description proceeds.

According to an aspect of the present invention, there is provided an auction information provision system for use in an electronic auction, comprising: a purchaser terminal for inputting purchaser's information of desired goods to be previously registered; an exhibitter terminal for searching the purchaser's information and for inputting exhibitter's information of exhibited goods for registration, the exhibitter's information being inputted when the exhibited goods comply with the purchaser's information; an auction management server for managing both the purchaser's information from the purchaser terminal and the exhibitter's information from the exhibitter terminal; a network through which the purchaser terminal and the exhibitter terminal are connected with the auction management server; the auction management server supplying the purchaser's information previously registered therein over the network; and the auction management server noticing the purchaser terminal that goods complying with the purchaser's information are exhibitted in the electronic auction, when exhibited goods corresponding to the purchaser s information are registered as the exhibitter's information from the exhibitter terminal.

The purchaser s information of desired goods may be transmitted by electronic mail (E-mail) from the purchaser to the auction management server, when the purchaser's information of desired goods are previously registered therein.

The purchaser's information of desired goods may be transmitted by telephone call from the purchaser to the auction management server, when the purchaser's information of desired goods are previously registered therein.

The purchaser's information of desired goods may be transmitted by mail from the purchaser to the auction management server, when the purchaser's information of desired goods are previously registered therein.

The purchaser may be identified for distinction from the other purchasers by E-mail address of the purchaser.

The purchaser may be identified for distinction from the other purchasers by telephone numbers of the purchaser.

The purchaser may be identified for distinction from the other purchasers by address of the purchaser.

According to another aspect of the present invention, there is also provided a method of providing auction information for use in an electronic auction, the method comprising the steps of: previously registering purchaser's information of desired goods on an auction management server through a network; supplying the purchaser's information over the network; searching the purchaser's information through the network and registering exhibitter's information of exhibited goods on the auction management server through the network, the exhibitter's information being registered when the exhibited goods comply with the purchaser's information in the searching step; and noticing that goods complying with the purchaser's information are exhibitted in the electronic auction, when exhibited goods corresponding to the purchaser's information are registered as the exhibitter's information.

### BRIEF DESCRIPTION OF THE DRAWINGS

FIG. 1 is a schematic diagram for showing a constitution of an auction information provision system according to a first embodiment of the present invention;

FIG. 2 is a schematic block diagram for functionally showing an user terminal in the auction information provision system illustratel in FIG. 1;

FIG. 3 is a flow chart for explaining an operation of the auction information provision system according to the first embodiment, in which an user is to take perticipate in the auction;

FIG. 4 is a flow chart for explaining an operation of the auction information provision system according to the first embodiment, in which an user is to exhibit his goods in the auction; and

FIG. 5 is a schematic diagram for showing a screen which is for use in perticipating in the auction and which is displayed in the user terminal in the auction information provision system according to the first embodiment of the present invention.

### DETAILED DESCRIPTION OF THE PREFERRED EMBODIMENTS:

[First Embodiment]

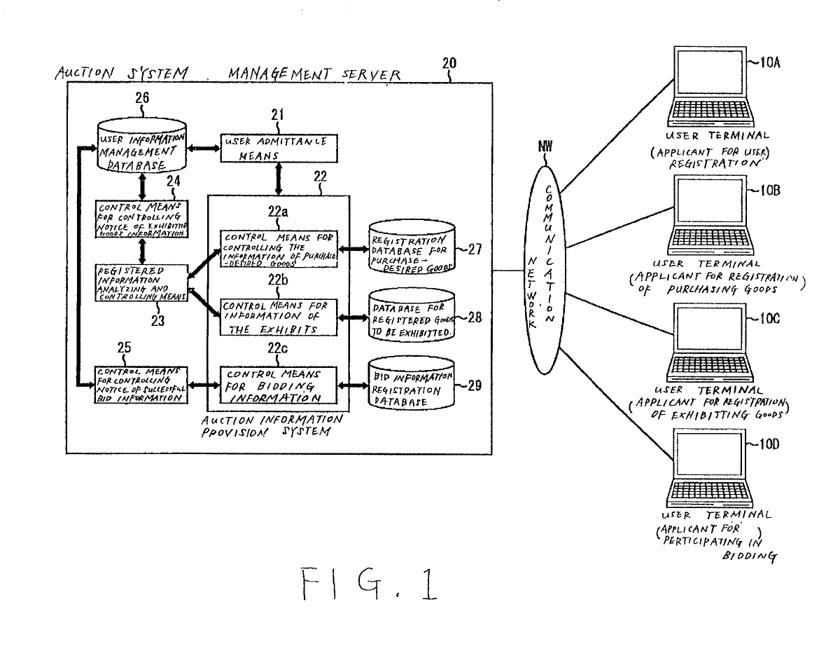

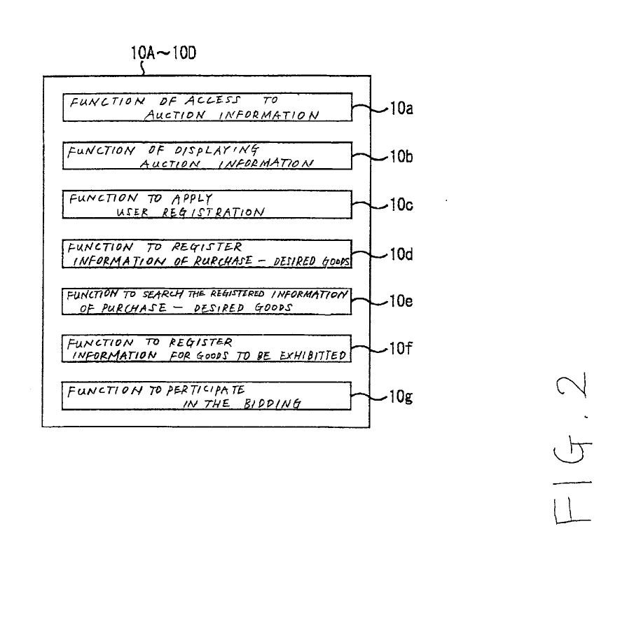

Referring now to FIGS. 1 and 2, description will proceed to an auction information provision system according to a first embodiment of the present invention. FIG. 1 is a schematic diagram for showing a constitution of the auction information provision system according to the first embodiment of the present invention. FIG. 2 is a schematic block diagram for functionally showing an user terminal in the auction information provision system illustratel in FIG. 1.

The auction information provision system according to the first embodiment is for use in an electronic auction. As illustrated in FIG. 1, the auction information provision system comprises user terminals 10A, 10B, 10C, and 10D. In this embodiment, the user terminal 10A is used by an user who wishes an user registration of the auction (applicant for user registration) while the user terminal 10B is used by an user (a perchaser) who wishes registration for purchasing desired goods in the auction (applicant for registration of purchasing goods). Further, in this embodiment, the user terminal 10C is used by an user (an exhibitter) who wishes registration for exhibitting goods (applicant for registration of exhibitting goods) while the user terminal 10D is used by an user (a bidder) who wishes to take perticipate in a bidding in the auction (applicant for perticipating in bidding). Besides, the user terminal 10B is used as a purchaser terminal for inputting purchaser's information of desired goods to be previously registered while the user terminal 10C is used as an exhibitter terminal for searching the purchaser's information and for inputting exhibitter's information of exhibited goods for registration. The exhibitter's information are inputted when the exhibited goods comply with the purchaser's information. Besides, the user terminals 10A, 10B, 10C, and 10D are information processing apparatus, such as personal computers, or the like. Herein, all of the user terminals 10A, 10B, 10C, and 10D have functions of the above-mentioned user registration, registration of purchasing goods, registration of exhibitting goods, and perticipating in bidding, respectively.

As illustrated in FIG. 1, the auction information provision system further comprises an auction system management server 20 used by an auction promoter and a communication network NW, such as the Internet, or the like which connects the above-mentioned user terminals 10A, 10B, 10C, 10D and the auction system management server 20 with each other. Besides, the auction system management server 20 is used by an auction promoter and is composed of information processing apparatus, such as a workstation server, and the like. Herein, the auction system management server 20 is also used for managing both the purchaser s information from the purchaser terminal 10B and the exhibitter's information from the exhibitter terminal 10C. The purchaser terminal 10B and the exhibitter terminal 10C are connected with the auction system management server 20 through the communication network NW. The auction system management server 20 supplies the purchaser's information previously registered therein over the communication network NW. The auction system management server 20 also notices the purchaser terminal 10B that goods complying with the purchaser's information are exhibitted in the auction, when exhibited goods corresponding to the purchaser s information are registered as the exhibitter's information from the exhibitter terminal 10C.

In this first embodiment, the purchaser's information of desired goods are transmitted by electronic mail (E-mail) from the purchaser to the auction system management server 20, when the purchaser's information of desired goods are previously registered therein. The purchaser is identified for distinction from the other purchasers by E-mail address of the purchaser.

As illustrated in FIG. 2, the user terminals 10A, 10B, 10C, 10D have functions to access auction information provided on the communication network NW by the auction system management server 20 (function of access to auction information 10a) and to display the auction information on a screen (function of displaying auction information 10b). The auction information are, for example, information for goods, such as personal computers, software, automobiles, furnitures, or the like. In such cases, the auction information include information such as names and prices of goods, image data of goods, explanation of goods, or the like.

The user terminals 10A, 10B, 10C, 10D have further functions to apply user registration 10c for perticipating in the auction, to register information for goods to be desirably purchased 10d, to search the registered information for goods to be desirably purchased 10e, to register information for goods to be exhibitted 10f, and to perticipate in the bidding 10g, respectively.

The function to apply user registration 10c, includes not only a function to transmit user information for perticipating in the auction from, for example, the user terminal 10A to the auction system management server 20 through the communication network NW but also a function to receive user admittance information replied by the auction system management server 20. The user information include personal information, such as E-mail address, a name, and the like of the user. The user admittance information include information, such as an ID number, a password, and the like for perticipating in the auction.

The function to register information for goods to be desirably purchased 10d includes a function to transmit the user admittance information and the information for goods to be desirably purchased from, for example, the user terminal 10B to the auction system management server 20 through the communication network NW. The information for goods to be desirably purchased include information of goods that the user wants to purchase in the auction, such as a name of the goods, prices at which the user wants to purchase the goods, and the like.

The function to search the registered information for goods to be desirably purchased 10e includes a function to transmit the user admittance information and the information for goods to be searched from, for example, the user terminal 10C to the auction system management server 20 through the communication network NW. The information for goods to be searched include keyword information, such as a name of the goods, and the like.

The function to register information for goods to be exhibitted 10f includes a function to transmit the user admittance information and the information for goods to be desirably exhibitted in the auction from, for example, the user terminal 10C to the auction system management server 20 through the communication network NW. The information for goods to be desirably exhibitted in the auction include information of goods that the user wants to sell in the auction, such as a name of the goods, prices of opening bid, minimum prices for selling the goods, image data of the goods, explanation of the goods, or the like.

The function to perticipate in the bidding 10g includes a function to transmit the user admittance information and bidding information for goods to be desirably purchased from, for example, the user terminal 10D to the auction system management server 20 through the communication network NW. The bidding information include information of a bid that the user can submit to the auction, or the like.

The auction system management server 20 has functions to receive user information transmitted from the user terminal 10A by operation of an auction attendant of which the user information have not yet been registered, to manage the user information by a user information management database 26, to produce user admittance information, and to transmit the produced user admittance information to the user terminal 10A. The user admittance information are such information for distinguishing an auction attendent that are produced per each user registration applicant as his own information.

The auction system management server 20 has further functions to receive the user admittance information and information for goods to be desirably purchased transmitted from the user terminal 10B by operation of a purchaser of which the user registration has already been applied, to manage the information for goods to be desirably purchased by a database 27 for registering goods to be desirably purchased, to produce completion information for registration of the purchase-desired goods, and to transmit the produced completion information to the user terminal 10B.

The auction system management server 20 has further functions to receive the user admittance information and information for goods to be desirably exhibitted transmitted from the user terminal 10C by operation of an exhibitter of which the user registration has already been applied, to manage the information for goods to be desirably exhibitted by a database 28 for registered goods to be exhibitted, to produce completion information for registration of the goods to be exhibitted,, and to transmit the produced completion information to the user terminal 10C.

The auction system management server 20 has further functions to receive the user admittance information and searched information for goods to be desirably sold in the auction transmitted from the user terminal 10C by operation of an exhibitter of which the user registration has already been applied, to search the registration database 27 for purchase-desired goods, to produce information for numbers of persons who wish to purchase and prices list (minimum prices and maximum prices), and to transmit the produced information to the user terminal 10C.

The auction system management server 20 has further functions to compare information for registered goods to be exhibitted with information for registered goods to be purchased, to produce information of exhibitted goods for the user of which the information for goods to be purchased have been registered, when conditions of both the information comply with each other, and to send an E-mail to the user of the user terminal 10B of which the information for goods to be purchased have been registered by the use of the E-mail address applied at the time of the user registration.

The auction system management server 20 has further functions to receive the user admittance information and bidding information transmitted from the user terminal 10D by operation of an auction attendent of which the user registration has already been applied, to manage the bidding information by a registration database 29 for bidding information, to control prices and a successful bidder for goods to be desirably purchased, to produce successful bid information when a successful bidder has been finally determined, and to send an E-mail to each of the successful bidder and the exhibitter by the use of each E-mail address applied at the time of the user registration. The successful bid information are such information for distinguishing not only an exhibitter and exhibitted goods thereof but also a successful bidder and prices of the successful bid. The successful bid information are produced per each successful bid as its own information.

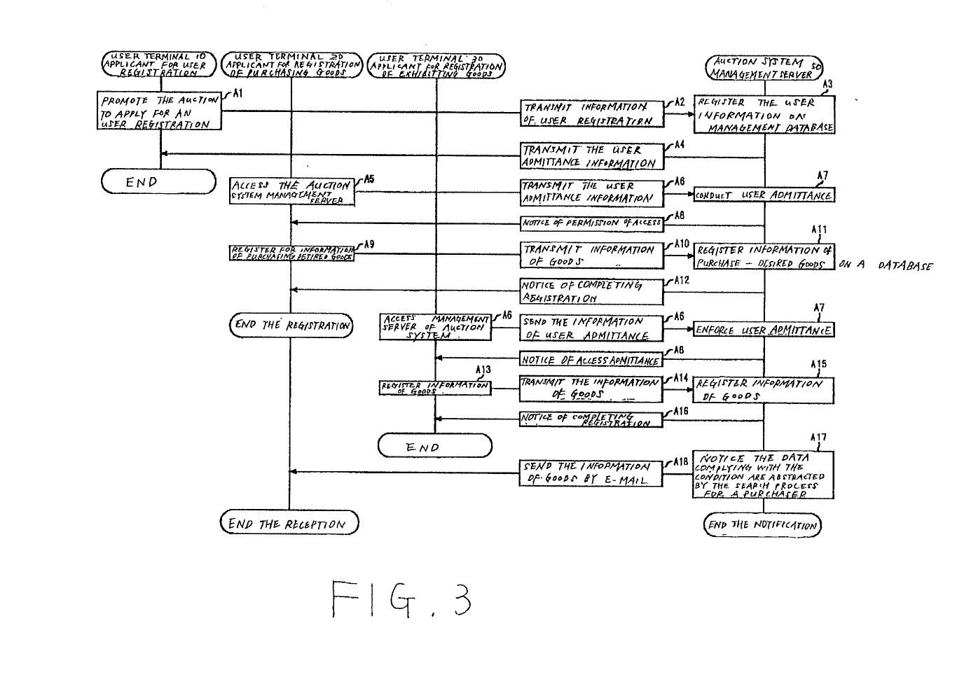

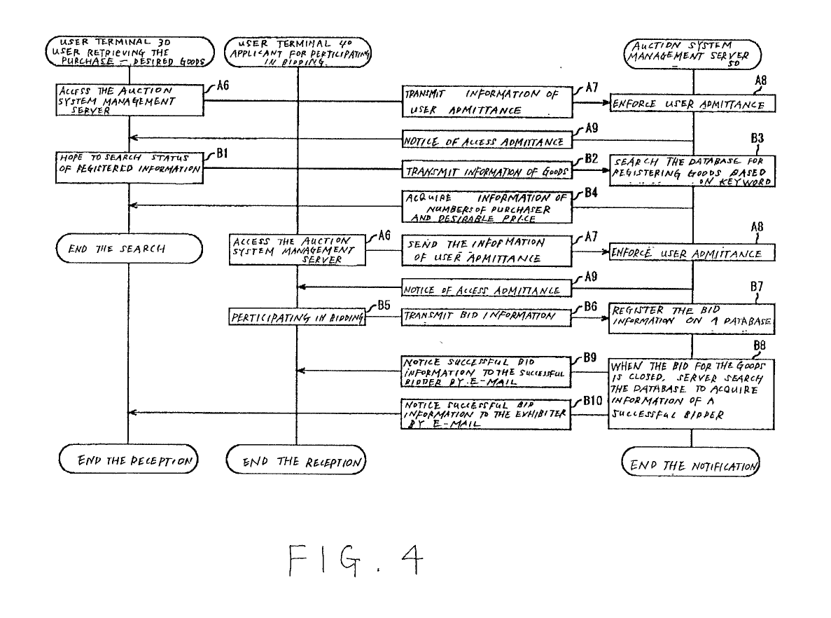

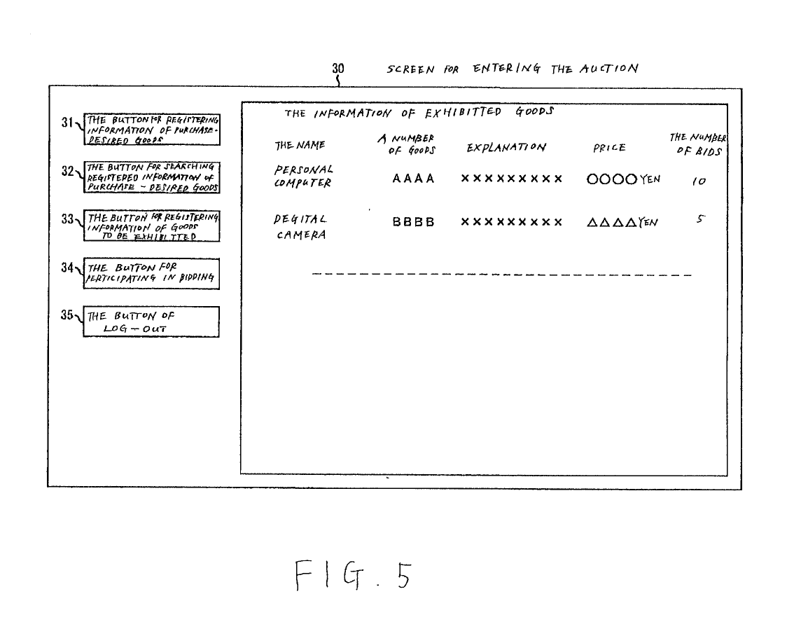

Next, referring to FIGS. 3 through 5 with reference to FIGS. 1 and 2 continued, a detailed description is made about an operation of the auction information provision system according to the first embodiment of the present invention. FIG. 3 is a flow chart for explaining an operation of the auction information provision system according to the first embodiment, in which an user is to take perticipate in the auction. FIG. 4 is a flow chart for explaining an operation of the auction information provision system according to the first embodiment, in which an user is to exhibit his goods in the auction. FIG. 5 is a schematic diagram for showing a screen which is for use in perticipating in the auction and which is displayed in the user terminal in the auction information provision system according to the first embodiment of the present invention. Besides, the communication network NW is hereinunder described as the Internet.

As illustrated in FIG. 3, at first, an user who wishes to perticipate in the auction accesses a homepage of the auction held over the Internet NW by the promoter of the auction to apply for an user registration (Step A1). The user then transmits information of a name and Email address of the user as user information to the auction system management server 20 (Step A2). In response thereto, the auction system management server 20 registers the user information on the user information management database 26 by the user admittance means 21 illustrated in FIG. 1. The auction system management server 20 issues an user ID and password information as user admittance information for perticipating in the auction (Step A3). The auction system management server 20 transmits the user admittance information to the user terminal 10A (Step A4). Accordingly, user registration for the auction has been completed.

Next, an user who has finished user registration for the auction and wishes to utilize auction information for registered user accesses a homepage of the auction held over the Internet NW by the promoter of the auction through respective user terminals 10A through 10D (Step A5). Further, in order to utilize auction information for registered user, the user transmits the user admittance information to the auction system management server 20 and accesses a screen of home page for registered user (Step A6). In response thereto, the auction system management server 20 conducts user admittance by the user admittance means 21 illustrated in FIG. 1 (Step A7). The auction system management server 20 transmits notice of permission of access to the user terminals 10A through 10D, when the user is admitted to be a member (Step A8). On the contrary, the auction system management server 20 does not permit the access, when the user admittance information is recognized to be untrue. A screen for use in perticipating in the auction illustrated in FIG. 5 is displayed on the user terminal 10A through 10D for which the user was permitted to access the screen.

Further, an user who wishes previous registration of goods to be desirably purchased in the auction clicks the button 31 for registering information of goods to be desirably purchased by the use of a mouse on a screen for use in perticipating in the auction illustrated in FIG. 5 (Step A9). The user can thereby register goods to be desirably purchased, so that the user makes and transmits information of goods to be desirably purchased (a name of goods, desirable prices, registration period, or the like) to the auction system management server 20 (Step A10). In response thereto, the auction system management server 20 registers the information of goods to be desirably purchased on a database for registering the goods to be desirably purchased by control means 22a for controlling the information of goods to be desirably purchased (Step A11). The auction system management server 20 then transmits a notice of completing registration to the user terminal 10B (Step A12). Accordingly, previous registration of goods to be desirably purchased for the auction has been completed.

Next, an user who wishes to exhibit goods in the auction clicks the button 33 for registering information of goods to be exhibitted by the use of a mouse on a screen for use in perticipating in the auction illustrated in FIG. 5 (Step A13). The registration of information of goods to be exhibitted is thereby conducted. The user makes and transmits the information of goods to be exhibitted (name of goods, explanation of goods, image data of goods, minimum price for opening bid, minimum price for successful bid, and the like) to the auction system management server 20 (Step A14). In response thereto, the auction system management server 20 registers the information of goods to be exhibitted on a database 28 for registering exhibitted goods by the use of the button 33 for registering information of goods to be exhibitted (Step A15). The auction system management server 20 issues a management ID (goods number) and then transmits a notice of completing registration to the user terminal 10D (Step A16). Further, the auction system management server 20 additionally displays information of exhibitted goods on a screen 30 for entering the auction illustrated in FIG. 5 based on the information of exhibitted goods. Accordingly, registration of goods to be exhibitted in the auction has been completed.

Next, the auction system management server 20 searches the database 27 for registering goods to be desirably purchased by registered information analyzing and controlling means 23 illustrated in FIG. 1 based on the name of goods in the information of exhibitted goods, when new information of exhibitted goods have been registered. When data complying with the condition are abstracted by the search process (Step A11), the auction system management server 20 searches the user information management database 26 based on the user ID by the control means 24 for controlling notice of exhibitted goods information to acquire the “E-mail address” of the user. The auction system management server 20 makes and sends “exhibitted goods information for goods to be desirably purchased” by Email to the user having the “E-mail address” (Step A18). Accordingly, notice of exhibitted goods information in the auction for a purchaser has been completed.

As illustrated in FIG. 4, an user who wishes to exhibit his goods in the auction clicks a button 32 for searching registered information of goods to be desirably purchased by the use of a mouse on the screen 30 for entering the auction illustrated in FIG. 5, when the user hopes to search status of registered intention of purchase for his goods to be exhibitted (Step B1). Thereby, registered information of goods to be desirably purchased can be searched. The user then makes and transmits information of goods to be searched (keyword consisting of a name of goods, or the like) to the auction system management server 20 (Step B2).

In response thereto, the auction system management server 20 searches the database 27 for registering goods to be desirably purchased by the control means 22a for controlling the information of goods to be desirably purchased, based on keyword information consisting of the name of goods, or the like. When data complying with the condition are abstracted by the search process (Step B3), the auction system management server 20 acquires information of numbers of persons who wish to purchase the goods and desirable prices for purchasing the goods (minimum prices and maximum prices). The auction system management server 20 then transmits the acquired information to the user terminal 10C (Step B4). Accordingly, search for goods to be desirably exhibitted has been completed.

Next, a user who wishes to perticipate in bidding of the auction clicks the button 34 for participating in bidding by the use of a mouse on a screen for use in perticipating in the auction illustrated in FIG. 5 (Step B5). The user can thereby perticipate in “Information of goods exhibitted in the auction” illustrated in FIG. 5. The user makes and transmits bid information (information of desirable prices for purchasing the goods) by selecting the goods (Step B6). In response thereto, the auction system management server 20 registers the bid information on a bid information registration database 29 by bid information control means 22c illustrated in FIG. 1 (Step B7). When the bid for the goods is closed, the auction system management server 20 searches the bid information registration database 29 to acquire information of a finally successful bidder (user ID of the successful bidder, user ID of the exhibitter, name of goods, the number of the goods, prices of the successful bid) (Step B8). The auction system management server 20 searches the user information management database 26 by control means 25 for controlling notice of successful bid information illustrated in FIG. 1 based on the user ID of the successful bidder and the user ID of the exhibitter. The auction system management server 20 thereby acquires E-mail addresses of both the successful bidder and the exhibiter. The auction system management server 20 notices successful bid information to the successful bidder by the E-mail based on “name of goods of the successful bid, the number of the goods, prices of the successful bid, and exhibiter's information (E-mail address of the exhibiter)” (Step B9). On the other hand, the auction system management server 20 notices successful bid information to the exhibiter by the E-mail based on “name of exhibitted goods, the number of the goods, prices of the successful bid, and the successful bidder's information (E-mail address of the successful bidder)” (Step B10). Accordingly, notice of successful bid information in the auction to both the successful bidder and the exhibiter has been completed.

As described above, according to the auction information provision system of the first embodiment of the present invention, some advantageous effects can be achieved.

First, information for the goods that users want to purchase in the auction are previously registered in the auction information provision system of the present invention. Accordingly, the an user who wishes to purchase goods in the auction can access a home page of the auction at the timing that exhibition information for desired goods are automatically sent from the side of the auction promoter. Consequently, the user who wishes to purchase the goods can surely take perticipate in bidding of the auction. It is not necessary for the user to search and confirm the status of exhibition for the desired goods by himself.

Second, an user who wishes to exhibit goods in the auction can search registered information for purchasing the goods to be exhibitted before the user actually exhibits the goods in the auction. As a result, the user who wishes to exhibit the goods can obtain information for popularity of the goods to be exhibitted (possibility of successful bid) and prices that possible purchasers have offered. Accordingly, the user who wishes to exhibit the goods can, to some extent, expect the status of bidding with respect to the goods to be exhibitted.

[Second Embodiment]

Now, description will proceed to an auction information provision system according to a second embodiment of the present invention.

In this embodiment, when an user who wishes to perticipate in the auction applies user registration, an address or a telephone number can be registered as user information in spite of E-mail address. Further, previous registration of information of goods to be desirably purchased can be conducted by telephone or mail. Moreover, when the goods to be desirably purchased are exhibitted, the auction promoter can send “information of exhibition of the goods to be desirably purchased” to persons who wish to purchase the goods by telephone or mail.

As described above, although telephone or mail is used as a communication network in the second embodiment, an user who wishes to purchase goods in the auction can previously register his desired goods to be purchased. Further, when the desired goods to be purchased are exhibitted in the auction, the user who wishes to purchase the goods can obtain exhibition information for the desired goods from the side of the auction promoter. Moreover, an user who wishes to exhibit goods in the auction can inquire registered information for purchasing the goods to the side of the auction promoter. As a result, the user who wishes to exhibit the goods can obtain information for the numbers of persons who want to purchase the goods and prices (minimum and maximum prices) at which the persons want to purchase the goods.

While the present invention has thus far been described in conjunction with only several embodiments thereof, it will be readily understood for those skilled in the art to put the present invention into various other manners.

For example, the user terminal (the purchaser terminal or the exhibitter terminal) is not restricted to a personal computer. The user terminal (the purchaser terminal or the exhibitter terminal) may be a handy phone capable of sending E-mail.

What is claimed is:

1. An auction information provision system for use in an electronic auction, comprising:
a purchaser terminal for inputting purchaser's information of desired goods to be previously registered;
an exhibitter terminal for searching said purchaser's information and for inputting exhibitter's information of exhibited goods for registration, said exhibitter's information being inputted when said exhibited goods comply with said purchaser's information;
an auction management server for managing both said purchaser's information from said purchaser terminal and said exhibitter's information from said exhibitter terminal;
a network through which said purchaser terminal and said exhibitter terminal are connected with said auction management server;
said auction management server supplying said purchaser's information previously registered therein over said network; and
said auction management server noticing said purchaser terminal that goods complying with said purchaser's information are exhibitted in said electronic auction, when exhibited goods corresponding to said purchaser s information are registered as said exhibitter's information from said exhibitter terminal.

2. An auction information provision system as claimed in claim 1, wherein said purchaser's information of desired goods are transmitted by electronic mail (E-mail) from the purchaser to said auction management server, when said purchaser's information of desired goods are previously registered therein.

3. An auction information provision system as claimed in claim 1, wherein said purchaser's information of desired goods are transmitted by telephone call from the purchaser to said auction management server, when said purchaser's information of desired goods are previously registered therein.

4. An auction information provision system as claimed in claim 1, wherein said purchaser's information of desired goods are transmitted by mail from the purchaser to said auction management server, when said purchaser's information of desired goods are previously registered therein.

5. An auction information provision system as claimed in claim 2, wherein said purchaser is identified for distinction from the other purchasers by E-mail address of said purchaser.

6. An auction information provision system as claimed in claim 3, wherein said purchaser is identified for distinction from the other purchasers by telephone numbers of said purchaser.

7. An auction information provision system as claimed in claim 4, wherein said purchaser is identified for distinction from the other purchasers by address of said purchaser.

8. A method of providing auction information for use in an electronic auction, said method comprising the steps of:
previously registering purchaser's information of desired goods on an auction management server through a network;
supplying said purchaser's information over said network;
searching said purchaser's information through said network and registering exhibitter's information of exhibited goods on said auction management server through said network, said exhibitter's information being registered when said exhibited goods comply with said purchaser's information in said searching step; and
noticing that goods complying with said purchaser's information are exhibitted in said electronic auction, when exhibited goods corresponding to said purchaser's information are registered as said exhibitter's information.
